(19) United States
(12) Patent Application Publication
(10) Pub. No.: US 2006/0221176 A1
(43) Pub. Date: Oct. 5, 2006

(54) Method and arrangement for connecting a multimedia terminal to a call center

(75) Inventors: Sergio Di Pietro, Thalwil (CH); Reto Gutmann, Birmensdorf (CH); Hansruedi Suter, Gossau (CH); Ruben Notari, Zuerich (CH); Rudolf Weidmann, Zuerich (CH)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS SWITZERLAND LTD., ZUERICH (CH)

(21) Appl. No.: 11/298,829

(22) Filed: Dec. 12, 2005

(30) Foreign Application Priority Data
Mar. 31, 2005 (EP) 05007040.8

(51) Int. Cl. H04N 7/14

(52) U.S. Cl. 348/14.08; 379/265.11

(57) ABSTRACT

To make full use of an existing call center infrastructure, it is proposed to connect an infrastructure of a multimedia terminal which is used to transmit a message to a remote desk center. This remote desk center makes or initiates, in the call center private branch exchange associated with the call center, a call from the circuit switched network. When this call is being put through, a video link between the multimedia terminal and the agent's workstation is established in parallel. In this way, the existing features of a call center, such as skill based routing, reporting, online monitoring, and the like can be put to further use.

### BACKGROUND OF THE INVENTION

The present invention relates to a method and an arrangement for connecting a multimedia terminal to a call center.

This document uses English language nomenclature and acronyms taken from the standards produced by the organizations known as ITU-T, ETSI and IETF, such as

| | |
|---|---|
| “CC” | call center; |
| “DSS1” | digital subscriber signaling system no. 1; |
| “VoIP” | voice over IP; |
| “SIP” | session initiation protocol. |

The use of standard terms and acronyms avoids uncertainties. A list of the acronyms, abbreviations, terms and expressions used can be found at the end of this document, of which it is an integral part.

The increasing rationalization and optimization of personnel resources in service organizations such as railroads, mail services and the like can often be associated with a decline in the actual breadth of services offered. For example in the case of small and medium-sized railroads, ticket offices are closed and replaced by automatic ticket machines.

It is technically possible to replace an automatic ticket machine by a virtual ticket office known as a “remote desk”. A remote desk includes a multimedia terminal through which a user can make contact with a customer adviser (known as an “agent”) situated at a remote location. The agent then takes the action needed for the requested service, and tickets or reservations can be printed out on a printer at the remote desk. Payment can be made through a unit in the usual way with a credit card, debit card or cash such as coins and notes.

Document FR 2 848 712 A1 “automate de forme humanoïde” (automaton in human form) S.A.S émotion system, Société par actions simplifiée” discloses such a remote desk in the form of a man. This solution implies providing a new infrastructure which has to be set up in parallel to an existing infrastructure such as a call center CC. In a known way, railroads and mail services have centralized or distributed call centers where information can be obtained or orders can be placed by calling a premium-rate telephone number. Operating remote desks in a coverage area therefore requires a “new” or parallel infrastructure, which nowadays includes a VoIP telephony platform and a dedicated call center infrastructure with supporting video communication. This solution offers no protection for the investment.

The economic significance of such remote desks is stated in the study Symposium ITXPO Using Technology to deliver Multichannel Integration 31 Oct.-4 Nov. 2004, Cannes; www.gartner.com by Gartner without indicating possible concrete solutions.

A possible alternative to the above-mentioned solution is to install a videoconference solution alongside the existing infrastructure of a conventional telephony call center. This alternative solution is not satisfactory for the call center operator and for the agents because:
the video call has no reporting option and the existing call center reporting is corrupted;
the video call has no online monitoring option and the existing call center online display is corrupted;
skill based routing is not supported and only a point to point connection is guaranteed, and
the agent has to use two different terminals: a telephone unit for the call center and a PC for the video service.

The SIP protocol is preferably used for implementing multimedia conference systems based on an in-house or externally available corporate network. Thus document WO 00/79756 A3 “System and method for providing value-added services (VAS) in an integrated telecommunications network using session initiating protocol (SIP)” discloses a system and a method for providing an added-value service in an integrated telecommunications network, the SIP protocol being used on one side and the INAP protocol being used on the network side for the added-value services.

### SUMMARY OF THE INVENTION

The object of the present invention is to specify a connection of virtual multimedia terminals to an existing telephony and call center infrastructure, whereby the known features of call centers such as skill based routing, reporting, online monitoring, etc., can be further exploited without occasioning any loss of existing investment.

With respect to the method this object is achieved by the features which will emerge from claim 1 and with respect to the arrangement the object is achieved by the features which will emerge from claim 6.

Due to the inventive steps in the method, according to which
A a message is transmitted from an application on the multimedia terminal to a remote desk center, said remote desk center being connected to the call center private branch exchange;
B on receiving the message the remote desk center initiates a call from the circuit switched telecommunications network via the call center private branch exchange;
C the call generated in method step B is put through to an agent's terminal;
D after the call has been successfully put through according to method step C a video link is established between the agent's terminal and the multimedia terminal;
   a method is created in which the features available from a call center can be further exploited, since each call from a multimedia terminal is handled via the public telecommunications network in the same way as a normal call and is therefore indistinguishable from such calls. In detail this situation has the following advantages:
   the investment in the existing call center and in the existing telephony infrastructure is protected.
   the call center management has the customary skill based routing mechanisms, even for the connected multimedia terminal outside the circuit switched telecommunications network.
   The call center management can further exploit the existing reporting mechanisms.
   The call center management has the customary online monitoring mechanisms.
   A call center agent takes a call from a multimedia terminal in the customary way and is then immediately connected to the multimedia terminal by video link.

Advantageous embodiments of the invention are specified in further claims.

### BRIEF DESCRIPTION OF THE SEVERAL VIEWS OF THE DRAWINGS

The invention will be explained in greater detail using the drawings by way of example. These show the following:

FIG. 1 Structure of a conventional call center and connection to a circuit switched telecommunications network;

FIG. 2 Additional components for connecting a multimedia terminal to a call center;

FIG. 3 Overview of the sequence of a message by which a call from a multimedia terminal can be handled with the aid of the physical resources of a call center, and

FIG. 4 Detailed sequence of the message according to the overview in FIG. 3.

### DETAILED DESCRIPTION OF THE INVENTION

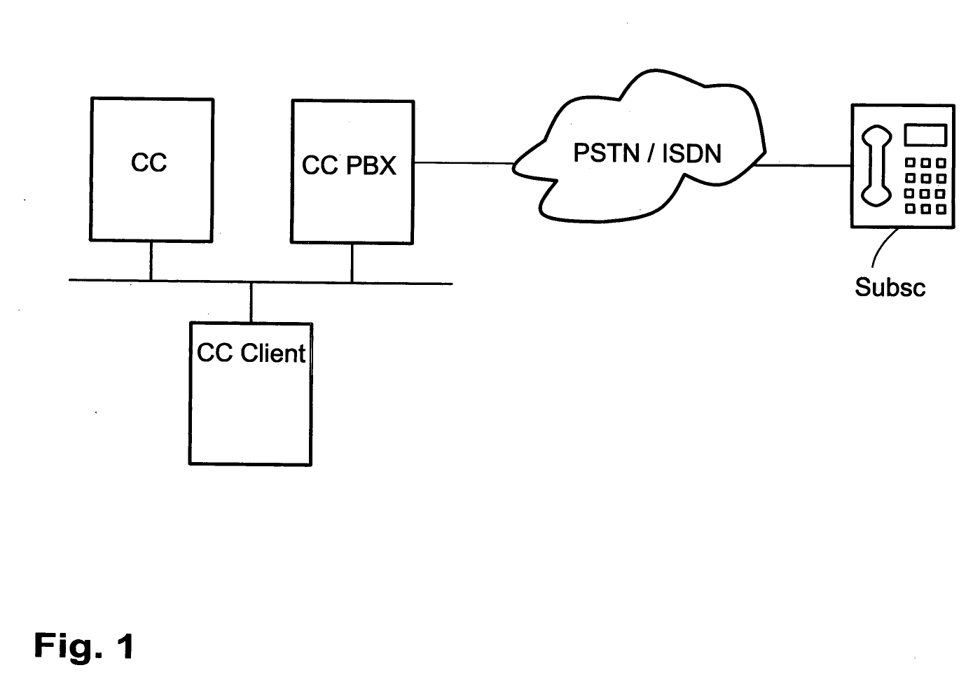

FIG. 1 shows the structure of a conventional call center CC. This provides for a call center private branch exchange CC PBX—also known as a subscriber's extension station—which is connected to a circuit switched telecommunications network PSTN/ISDN. An incoming call from a subscriber Subsc is then allocated to a particular agent, in other words to a specific person, on the basis of certain criteria such as the call number. The agent can then use a telephone, preferably with a headset, that can be connected to a workstation PC on a centralized or distributed basis. With the aid of this connection it is possible, even before the call has come in, to build up the context of the caller, for example on the basis of the call number stored for the customer concerned. This connection takes place via a link known as a counterpart interface. The call center itself can be based on circuit switched technology or, as an alternative to the preceding information, on the technology known as VoIP. In this case all data and information, and in particular also the voice service, are processed by the agent via the same medium and the same applications. In the typical embodiment of the present invention which is about to be explained, the call center is assumed to have a client-server infrastructure. Therefore a CC Client is entered in FIG. 1 to represent the plurality of agents' workstations.

In the context of this document, a virtual multimedia terminal means a remote desk RD, situated at a distance from the Call Center CC, that can be used by the public to ask for information, or to order or buy a service or product, without personally having to take the individual steps involved in selecting the service or product. The remote desk RD runs an application RDS which in the final analysis is the function of said remote desk RD. In the context of this document the expression multimedia terminal is used in place of the term remote desk RD.

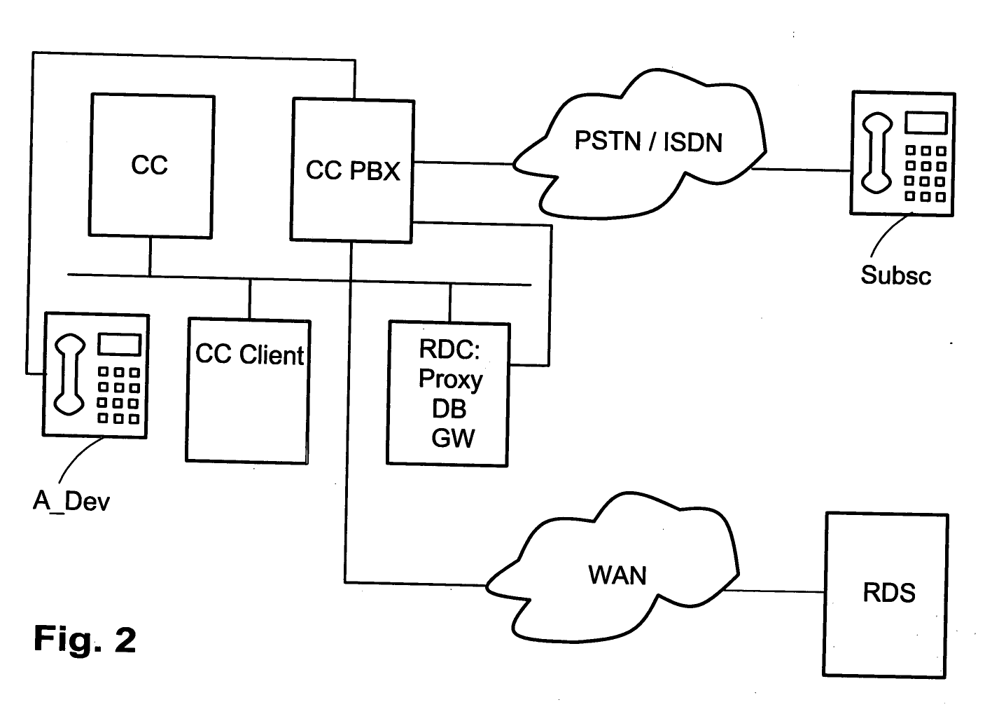

The components needed for connecting a plurality of such multimedia terminals RD are explained at the function level in FIG. 2. An application RDS running on the multimedia terminal RD is connected to the call center CC via a network WAN. A remote desk center RDC is also provided, and contains the central components gateway GW, database DB and SIP proxy.

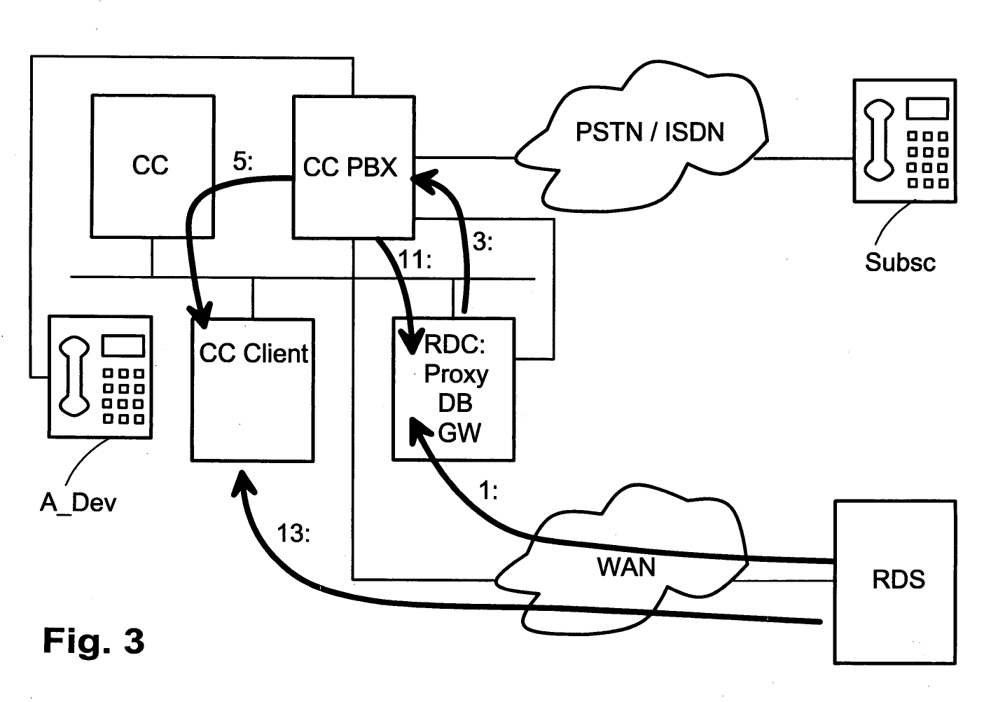

The individual steps involved in making and establishing the connection are shown in the overview in FIG. 3. The connection is established in the overview as follows:
The customer goes to multimedia terminal RD, which may for instance be a multimedia PC, on which a remote desk service RDS is running. Such a multimedia terminal RD is designed to be reasonably vandal resistant.
The customer uses a graphical interface GUI to select the language in which he or she prefers to be served, as well as the specialist knowledge required of the adviser, that is to say the agent, who needs to be contacted. These entries are evaluated by the subscriber's extension station CC PBX so that a call is routed to the agent who most closely matches the profile requested by the customer. In the technical jargon this type of call distribution is known as “skill based routing”.
The application RDS now knows the customer's wishes with regard to language and agent capability, and initiates a voice connection to the RDC. The corresponding message flow is shown as “1:” in FIG. 3. During this time a video queue is displayed to the customer.

The remote desk center RDC initiates or makes a call Call in the existing telephony/call center infrastructure CC PBX, indicated by “3:” in FIG. 3. The target of the call then depends, as previously explained, on the choice made by the customer on the remote desk RD.

This call is handled by the existing telephony/call center infrastructure as a normal call from a customer and distributed to a free agent. This is indicated by “5:”. The terminal used by the agent is represented symbolically by A_Dev. As previously explained, this embodiment is based on a client-server infrastructure for the call center workstations.

When the agent takes the call, the existing telephony infrastructure notifies the telephone number of the agent concerned to the remote desk center RDC, for example via DSS1, Q-SIG or other CC PBX protocols; the corresponding message is indicated by “11:”.

The remote desk center RDC will allocate the SIP URI of the appropriate agent's PC to the notified telephone number and report it to the application RDS on the multimedia terminal RD.

The application RDS now uses SIP protocol to establish a video link to the notified SIP URI, for which see “13:” in FIG. 3.

Because the connection between the application RDS and the video application RDA of the remote desk agent RDA is established in parallel to a normal call, this call can be monitored by the call center.

This connection of a multimedia terminal RD ensures that:
The video call is statistically logged;
online monitoring such as queue status and agent status is also ensured for the video call
“skill based routing” is also possible for a video call by virtue of being established like a normal call.

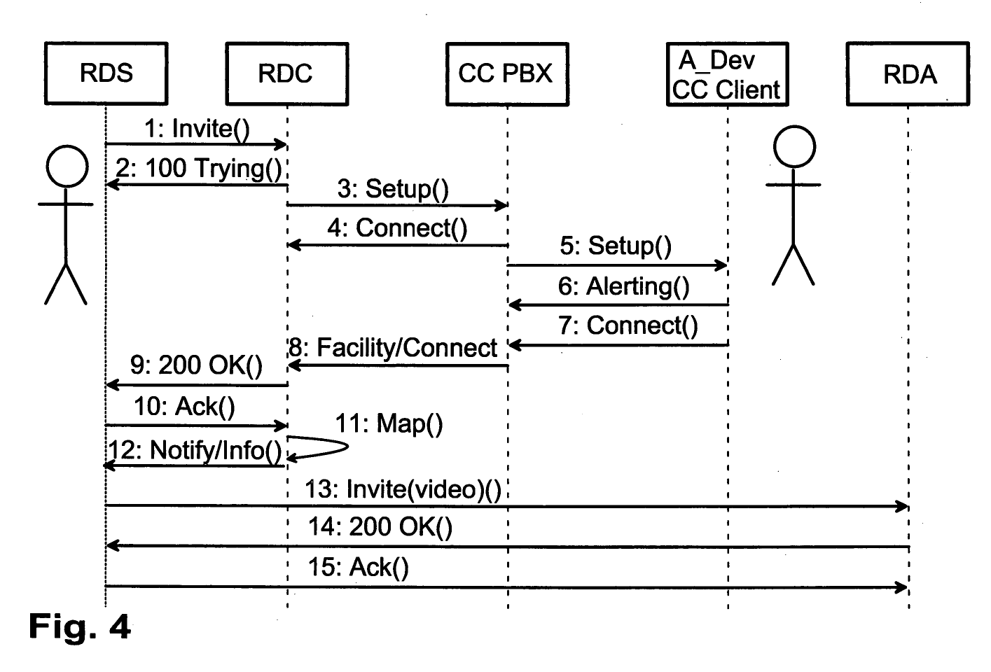

Details of the flow of messages to which FIG. 4 relates are as follows:

1: INVITE RDS→RDC:

The customer decides to contact the call center CC and presses the appropriate button on the graphical interface GUI of the application RDS. This sends a SIP INVITE message to the RDC. It should be noted at this point that the remote desk center RDC registers a plurality of SIP URIs, one for each service number assigned to the video service in the call center. The application RDS decides on the basis of the customer's choice which SIP URI to contact.
   2: 100 TRYING RDC→RDS:
The remote desk center RDC notifies the application RDS that the INVITE message has been accepted.
   3: SETUP RDC→CC PBX
A call to the call center CC PBX is initiated by the remote desk center RDC. The chosen service number is dependent on the SIP URI in the “To:” header field of the INVITE message. The remote desk center RDC has a table where the mapping from SIP URI→service number is defined. This can be designed as part of the database DB. The call center private branch exchange CC PBX tries to put the call (voice service) through to a free agent.
   4: CONNECT CC PBX→RDC
In the event that no agent is free, the call center private branch exchange CC PBX could connect the call temporarily to a voice announcement port. In this case a CONNECT message is sent from the CC PBX to the remote desk center RDC. Said center has to analyze the CONNECT message and check whether the call is to be put through to an agent or connected elsewhere. This check makes use of the “connected number” parameter. This is only possible if the possible call numbers of the agents are available in the remote desk center.
   5: SETUP CC PBX→agent's telephone terminal A_Dev
The call center private branch exchange CC PBX finds a free agent and hands on the call to said agent or to the terminal A_Dev allocated to said agent.
   6: ALERTING agent's telephone A_Dev→CC PBX
The agent's telephone terminal A_Dev rings.
   7: CONNECT agent's telephone→CC PBX
The agent answers.
   8: FACILITY or CONNECT CC PBX→RDC
As soon as the agent answers, a CONNECT message or FACILITY message (if the call is still connected to an announcement port, see 4:) is generated from the CC PBX to the remote desk center RDC. This message must without fail contain the call number of the agent, that is, “connected number” in the CONNECT message or “redirection number” in the FACILITY message, in order to enable this sort of connection or integration.
   9: 200OK RDC→RDS
The application RDS on the terminal RD is notified that the call has been answered by an agent.
   10: ACK RDS→RDC
The remote desk center RDC is notified that the application RDS on the terminal RD has received the 200 OK message.
In this way the first session is established between the RDS and the RDC. The audio channel is established via this session. Audio data flows from the RDS to the RDC and from the RDC via the CC PBX to the agent's telephone A_Dev.
   11: Resolving the RDA SIP URI
The remote desk center RDC knows the call number of the agent and has to find the associated SIP URI. The call number/SIP URI association could for example be stored in a configuration file.
   12: NOTIFY or INFO RDC→RDS
The remote desk center RDC hands on the SIP URI of the agent's video application via a NOTIFY message or an INFO SIP message of the application on the terminal RD.
   13: INVITE RDS→RDA
The application RDS now knows the SIP URI of the agent who answered the first call and can establish a direct session to the video application RDA. This second session serves to establish video communication between the application RDS and the video application RDA.
   14: 200 OK RDA→RDS
The video application RDA accepts the INVITE message.
   15: ACK RDS→RDA
The video application RDA is notified that the application RDS on the terminal RD has received the 200 OK message. The second session is established, and video data can then flow directly between the applications RDS and RDA.

A further implementation of the present invention can be carried out as follows:

The customer contacts the call center using a normal SIP client. The RDC establishes the session for the video service to the application RDA; video data flows from the SIP client to the remote desk center RDC from where it is forwarded to the application RDA. The advantage of this implementation is that the customer needs no specialist application in order to communicate with the call center. The principle dealing with integration into the call center is the same however.

A further alternative is video integration into an existing VoIP call center infrastructure. In this case the RDC will work with a CC VoIP unit rather than a CC PBX, but the overall sequence remains the same.

List of the acronyms and reference characters used
A_Dev agent's workstation, agent's workplace, agent's terminal
Agent adviser, person at call center
CC call center
CC Client application running on an agent's terminal
CC PBX call center private branch exchange
DB database
DSS1 digital subscriber signaling system no. 1
MCU multipoint control unit
PSTN public switched telephone network
Q-SIG Q interface signaling protocol
RD multimedia terminal, remote desk, terminal
RDA remote desk agent, agent's video application
RDC remote desk center, central components including gateway GW, database DB and SIP proxy
RDS remote desk service, customer's application on the RD
SIP session initiation protocol to IETF RFC 3261
Subsc subscriber; not a person
URI uniform resource identifier
User customer on the RD terminal
VoIP voice over IP
WAN wide area network

What is claimed is:

1. A method for connecting a multimedia terminal to a circuit switched telecommunications network connected call center, the method comprising the steps of:
connecting the call center via a call center private branch exchange to the public circuit switched telecommunications network, the call center including a plurality of agent's terminals;
connecting the multimedia terminal to a packet switched network;
transmitting a message from an application on the multimedia terminal to a remote desk center, the remote desk center being connected to the call center private branch exchange;
making a call by the remote desk center from the circuit switched telecommunications network via the call center private branch exchange upon receiving the message;
putting the call generated in the step of making a call through to an agent's terminal; and
establishing a video link between the agent's terminal and the multimedia terminal after the call has been successfully put through according to the step of putting the call.

2. The method according to claim 1, wherein in the step of putting the call, further comprises the step of transmitting a message containing the call number of the agent's terminal from the call center private branch exchange to the remote desk center.

3. The method according to claim 2, wherein the remote desk center comprises a database and for executing method step D in the remote desk center an allocation of the telephone numbers of agents' terminals to the addresses of the video applications running on the agents' terminals is stored in the database.

4. The method according to claim 3, wherein the step of establishing a video link further comprises the steps of:
transmitting the address of the video application running on the agent's terminal to the application running on the multimedia terminal with the aid of a message;
transmitting the address of the application running on the multimedia terminal to the video application running on the agent's terminal with the aid of a message.

5. The method according to claim 1, wherein for the flow of messages between the application on the multimedia terminal and the applications on an agent's terminal the SIP protocol is set according to RFC 3261.

6. An arrangement for connecting a multimedia terminal to a circuit switched telecommunications network connected call center, comprising:
a call center connected via a call center private branch exchange to the public circuit switched telecommunications network, the call center comprising a plurality of agent's terminals;
the multimedia terminal connected to a packet switched network;
the call center private branch exchange arranged to be connected via a remote desk center to the multimedia terminal, in which a message is transmitted to the remote desk center by an application on the said multimedia terminal;
means for making a call from the circuit switched telecommunications network via the call center private branch exchange in accordance with the message received provided in the remote desk center;
means for establishing a video link, after successfully putting through the initiated call to an agent's terminal, between the agent's terminal and the multimedia terminal.

7. The arrangement according to claim 6, wherein the remote desk center comprises a database in which an allocation of the telephone numbers of agents' terminals to the addresses of the video applications running on the agents' terminals is stored.

8. The arrangement according to claim 6, wherein the remote desk center comprises a gateway for communicating with the call center private branch exchange.

9. The arrangement according to claim 6, wherein the multimedia terminal comprises a printer for issuing tickets and a unit for paying with cash or credit card.
